(19) United States
(12) Patent Application Publication
(10) Pub. No.: US 2007/0151834 A1
(43) Pub. Date: Jul. 5, 2007

(54) Steering column switch

(76) Inventors: Daniel Horst, Bietigheim-Bissingen (DE); Reiner Mozer, Vaihingen/Enz (DE)

Correspondence Address: DREISS, FUHLENDORF, STEIMLE & BECKER, POSTFACH 10 37 62, D-70032 STUTTGART, DE

(21) Appl. No.: 10/586,389

(22) PCT Filed: Dec. 22, 2004
(86) PCT No.: PCT/EP04/14566

§ 371 Date: Jul. 17, 2006

(30) Foreign Application Priority Data
Jan. 23, 2004 (DE) 10 2004 004 507.0

(51) Int. Cl. H01H 9/00

(52) U.S. Cl. 200/61.54

(57) ABSTRACT

A steering column switch comprises at least one switch lever having an actuating element, with the inner side thereof having a gate which is adjacent to a support and with at least one associated microswitch. An end of a tappet, which is guided in the support is in contact with the gate and the other end thereof is in contact with the microswitch.

The invention concerns a steering column switch comprising at least one control lever having an actuating element provided on its inner side with a gate disposed next to a support which houses at least one microswitch.

There are a plurality of conventional steering column switches. These steering column switches are disposed on the upper end of the steering column below the steering wheel and may be actuated without releasing the steering wheel. The steering column switches are provided with one or more control levers which comprise, in turn, a plurality of switching functions. These control levers have turning and/or sliding switches and keys for generating switching commands for electrical units.

Since the individual control levers should have a large number of switches and at the same time be small, there is a demand for a simple, space-saving and inexpensive construction.

It is therefore the underlying purpose of the invention to design a steering column switch of the above-mentioned type in such a manner that it provides reliable function, at the same time being small and inexpensive to produce.

This object is achieved in accordance with the invention with a steering column switch of the above-mentioned type in that a tappet is guided in the support, one end of which is supported on the gate and the other end on the microswitch.

The inventive construction of a steering column switch has the substantial advantage that only one tappet is required to transfer the switching motions from the gate to the microswitch, such that the switching commands generated by the gate can be passed on directly to the microswitch without deflection. The microswitches can be actuated without a lever mechanism, and the shape of the gate corresponds exactly to the switching path of the microswitch. The switching paths of the gate need not be translated for actuation of the microswitch. The risk of damaging, in particular, kinking the lever mechanics is also eliminated. Finally, the switching paths are shorter compared to prior art and the gate path may therefore have steeper sections.

In one embodiment, the actuating element is displaceable transversely or parallel to the longitudinal axis of the control lever. By displacing the actuating element in this way, the gate comprising the gate path or the contact cams is guided over the tappet enabling the latter to perform the switching motion.

In a further embodiment, the actuating element is designed as a sleeve that can be turned about the longitudinal axis of the control lever. The switching commands are transferred to the tappet and thereby to the microswitch by turning the sleeve having the gate on an inner side thereof. The sleeve may preferably be designed to be rotatable about its longitudinal axis and also be displaceable in the direction of its longitudinal axis to associate the tappet with another gate.

In a further development, the tappet is supported on the gate under the force of the switching element of the microswitch. No spring elements or other means are therefore required to retain the tappet without play on the microswitch and also on the gate, i.e. the gate path. Direct abutment of the tappet on the microswitch and on the gate moreover yields very short switching paths, such that the switching processes can be quickly realized. Moreover, the individual contact cams of the gate may be disposed close to each other to increase the number of switching positions. In particular, the angle of rotation for switching of a rotatable actuating element can be reduced. Moreover, the switching accuracy is improved.

A new switching logic can advantageously be generated by replacing the gate, i.e. by using a different cam path.

The tappet is advantageously disposed in the support in a radial direction relative to the longitudinal axis of the control lever, thereby utilizing the entire height of a cam as an adjustment path for actuating the microswitch. Moreover, identical forces act on the tappet during switching on and off.

In order to save space and generate space for other components, e.g. boards and electrical leads within the control lever, the microswitch is advantageously disposed in the support substantially in the region of the longitudinal axis of the control lever, i.e. in its center, in particular, on a board.

In order to minimize the wear on the gate and also on the end of the tappet facing the gate, the end of the tappet abutting the gate is rounded or provided with a roller. The use of a roller obviates permanent lubrication, in particular, grease lubrication.

If the gate path extends parallel to the longitudinal axis of the control lever, the axis of rotation of the roller extends transversely to the longitudinal axis of the control lever, whereas, when the gate path extends transversely to the longitudinal axis of the control lever, e.g. in case of a rotatable sleeve, the axis of rotation of the roller extends parallel to the longitudinal axis of the control lever.

The roller may be mounted to the tappet end in a simple fashion by providing the roller with axle journals at its front sides which can be locked into recesses having open edges and forming the free end of the tappet. This facilitates automatized assembly.

The material and weight is reduced by the hollow design of the tappet and by closing its end abutting the microswitch.

In accordance with the invention, the number of switching positions can be increased by providing several gates next to each other in a longitudinal direction on the actuating element. In accordance with a further development of the invention, this plurality of gates is associated with several tappets and microswitches in the support. The plurality of microswitches are thereby connected to each other via a binary code, such that e.g. eight switching positions require three gates, three tappets and three microswitches.

The assembly is further facilitated in that the microswitches are part of a switching matrix. The inventive support may be completely assembled from one side by initially inserting the switching matrix and subsequently inserting the tappets, optionally with locked rollers, from one side into corresponding guidances.

Further advantages, features and details of the invention can be extracted from the following description which describes in detail a particularly preferred embodiment with reference to the drawing. The features shown in the drawing and mentioned in the description and the claims may be essential to the invention either individually or collectively in arbitrary combination.

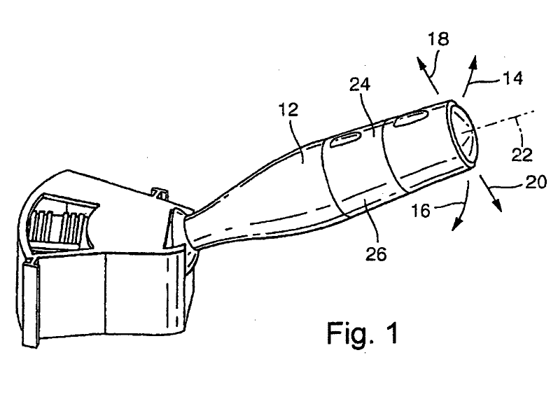

FIG. 1 shows a perspective view of a steering column switch;

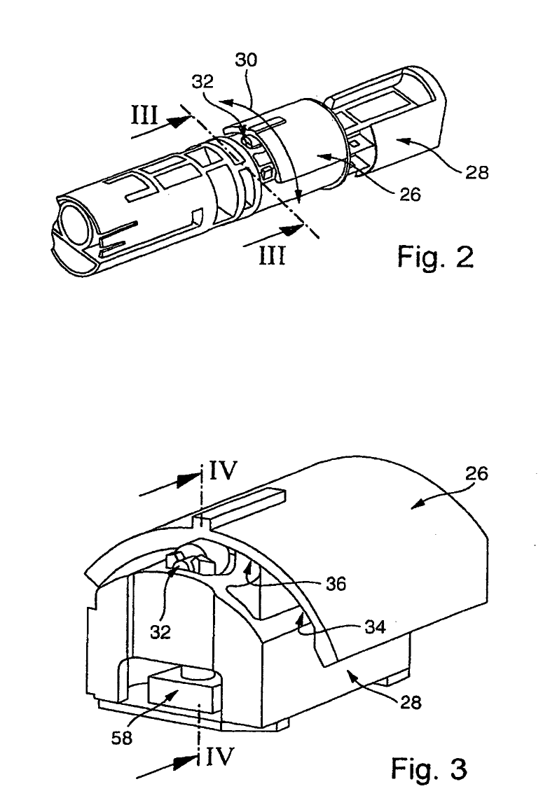

FIG. 2 shows a perspective view of the end of a control lever which is partially broken off;

FIG. 3 shows a section through III-III of FIG. 2 in an enlarged scale; and

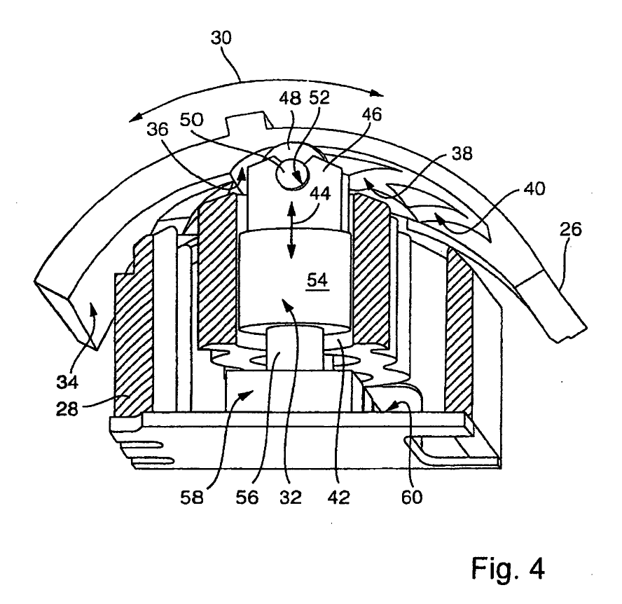

FIG. 4 shows a section through IV-IV in accordance with FIG. 3.

FIG. 1 shows a steering column switch which is designated in total with 10 and which can be mounted in the region of the upper end of a steering column (not shown), below a steering wheel (not shown). The steering column switch 10 has a control lever 12 which can be pivoted in the direction of the arrows 14 and 16. The control lever 12 can also be pivoted in the direction of arrows 18 and 20, providing additional switching functions. The control lever 12 also comprises an actuating element 24 which can be rotated about its longitudinal axis 22. This actuating element 24 is designed as sleeve 26 and described in more detail in the following figures. Alternatively or additionally, a slider may be provided as actuating element 24 which can be displaced in the direction of the longitudinal axis 22 or transversely thereto.

FIG. 2 shows part of the sleeve 26 which is supported on a support designated in total with 28. The sleeve 26 may be turned on the support 28 in the direction of double arrow 30, thereby actuating a tappet designated in total with 32.

This tappet 32 shown in an enlarged scale in the sectional view of FIG. 3, is supported on the inner side of the sleeve 26 under the force of a spring. FIG. 3 also shows that the inner side 34 of the sleeve 26 is provided with a gate 36 for actuating the tappet 32 in its axial direction when the sleeve 26 is turned.

FIG. 4 shows a section IV-IV in accordance with FIG. 3. A total of three gates 36 through 40 are clearly shown with a total of three tappets 32 abutting thereon, of which only the front tappet is shown. The front tappet 32 will be described below, wherein the description is also valid for the other tappets.

The tappet 32 can be displaced in a tappet guidance 42 in a longitudinal direction of arrow 44 and thereby substantially radially with respect to the longitudinal axis 22 of the control lever 12. The tappet 32 has a free end 46 to which a roller 48 is mounted. Towards this end, the roller 48 is provided with axle journals 50 projecting past the two front sides of the roller 48 and locked in recesses 52 of the tappet 32 provided on the free end 46. The opposite end 54 of the tappet 32 is supported on a spring-loaded switching element 56 of a microswitch 58 which, in turn, is mounted to a board 60. The tappet 32 is supported on the gate 36 of the sleeve 26 under the spring force of the switching element 56. A total of three microswitches 58 are provided on the board which may be combined into a switching matrix (FIG. 4).

It is possible to realize very short switching paths, and therefore a large number of sequential switching positions with a small angle of rotation using a steering column switch 10 of this type. The haptic effect and switching accuracy are moreover improved due to coupling at the maximum radius. A new switching logic can be generated by replacing the gate path. The inventive steering column switch is less expensive, since standard switching systems are used and the number of components are reduced.

1-16. (canceled)

17. A steering column switch, comprising:
at least one control lever;
an actuating element cooperating with said control lever,
said actuating element having a gate disposed on an inner side thereof;
a support;
at least one micro switch housed within said support; and
a tappet guided within said support, said tappet having a first end cooperating with said gate and a second end cooperating with said micro switch.

18. The steering column switch of claim 17, wherein said actuating element can be displaced transversely or parallel to a longitudinal axis of said control lever.

19. The steering column switch of claim 17, wherein said actuating element is designed as a sleeve which can be rotated about a longitudinal axis of said control lever.

20. The steering column switch of claim 17, wherein said micro switch comprises a switching element having a restoring force urging said tapped against said gate.

21. The steering column switch of claim 17, wherein said tappet is disposed in a radial direction in said support, relative to a longitudinal axis of said control lever.

22. The steering column switch of claim 17, wherein said micro switch is disposed in said support substantially in a region of a longitudinal axis of said control lever.

23. The steering column switch of claim 17, wherein said first end of said tappet abutting said gate is rounded.

24. The steering column switch of claim 17, wherein said first end of said tappet abutting said gate comprises a roller.

25. The steering column switch of claim 24, wherein said actuating element is designed as a rotatable sleeve or can be displaced transversely to a longitudinal axis of said control lever, wherein an axis of rotation of said roller extends parallel to a longitudinal axis of said control lever.

26. The steering column switch of claim 24, wherein said actuating element can be displaced parallel to a longitudinal axis of the control lever and an axis of rotation of said roller extends transversely to a longitudinal axis of said control lever.

27. The steering column switch of claim 24, wherein said roller has axle joints at front sides thereof which can be locked into recesses having open edges which are defined on said first end of said tappet.

28. The steering column switch of claim 17, wherein said tappet is hollow and said second end abutting said micro switch is closed.

29. The steering column switch of claim 17, wherein several gates are disposed on said actuating element next to each other in a longitudinal direction thereof.

30. The steering column switch of claim 29, wherein several said tappets and associated said micro switches are disposed in said support.

31. The steering column switch of claim 30, wherein said micro switches are part of a switching matrix.

32. The steering column switch of claim 30, wherein said micro switches are mutually switched via a binary code.
